(19) United States
(12) Patent Application Publication
(10) Pub. No.: US 2025/0263260 A1
(43) Pub. Date: Aug. 21, 2025

(54) SHEET CONVEYOR APPARATUS

(71) Applicants: Prime Planet Energy & Solutions, Inc., Tokyo (JP); JTEKT CORPORATION, Aichi-ken (JP)

(72) Inventors: Masayuki HORI, Himeji-shi (JP); Masateru MIKAMI, Himeji-shi (JP); Tetsuya SATO, Kobe-shi (JP); Toshikazu SAKEI, Toyoake-shi (JP)

(21) Appl. No.: 19/051,169

(22) Filed: Feb. 12, 2025

(30) Foreign Application Priority Data
Feb. 21, 2024 (JP) 2024-024581

(51) Int. Cl. B65H 5/22; B65H 5/06

(52) U.S. Cl. CPC B65H 5/228; B65H 5/06; B65H 5/222

(57) ABSTRACT

A sheet conveyor apparatus includes an air turn bar and a hood. The air turn bar turns back a strip-shaped sheet conveyed along a predetermined conveyance passage. The hood includes an inner circumferential surface that opposes an outer circumferential surface of the air turn bar. The outer circumferential surface of the air turn bar includes ejection holes ejecting air toward one surface of the sheet. The inner circumferential surface of the hood includes suction holes sucking air from the other surface of the sheet.

### CROSS REFERENCE TO RELATED APPLICATIONS

The present application claims priority from Japanese Patent Application No. 2024-024581 filed on Feb. 21, 2024, which is incorporated by reference herein in its entirety.

### BACKGROUND

The present disclosure relates to a sheet conveyor apparatus.

JP 2023-003004 A discloses a dryer apparatus that dries a conveyed material by ejecting gas thereto. The dryer apparatus disclosed in the publication includes an air turn bar for changing the orientation of the conveyed material. The air turn bar includes a wall part and a flow guide part. The gas is ejected from the wall part. The flow guide part includes a flat surface that extends the wall surface of the wall part toward the upstream of the conveying direction. It is stated that such a dryer apparatus is able to prevent the conveyed material from forming wrinkles.

JP 2021-050051 A discloses a turn bar including a turn bar body and a backside support part. The turn bar body has an ejection face provided with a plurality of ejection ports. The turn bar body ejects a first gas, which is pumped from outside, from the plurality of ejection ports toward the surface of a base material and changes the conveying direction of the base material while causing the base material to float from the ejection face. The backside support part is provided on the opposite side across the floated portion of the base material that is floated from the ejection face. The backside support part supports the entire backside surface of the floated portion of the base material. It is stated that such a turn bar allows the amount of the floated base material to be uniform and to change the conveying direction of the base material in a stable manner.

### SUMMARY

When a strip-shaped sheet is turned back by an air turn bar, there is a fear that the sheet may comes into contact with the air turn bar if the sheet is not stably turned back.

According to the present disclosure, a sheet conveyor apparatus includes an air turn bar and a hood. The air turn bar turns back a strip-shaped sheet conveyed along a predetermined conveyance passage. The hood includes an inner circumferential surface that opposes an outer circumferential surface of the air turn bar. The outer circumferential surface of the air turn bar includes ejection holes ejecting air toward one surface of the sheet. The inner circumferential surface of the hood includes suction holes sucking air from the other surface of the sheet. The sheet conveyor apparatus as described above allows turning back of the sheet to be stable.

### BRIEF DESCRIPTION OF THE DRAWINGS

FIG. 1 is a schematic view of a sheet conveyor apparatus 10.

FIG. 2 is a schematic cross-sectional view of an air turn bar 20 and a hood 30.

FIG. 3 is a schematic plan view of the air turn bar 20.

### DETAILED DESCRIPTION

Hereinbelow, embodiments of the technology according to the present disclosure will be described with reference to the drawings. It should be noted, however, that the disclosed embodiments are, of course, not intended to limit the disclosure. The drawings are depicted schematically and do not necessarily accurately depict actual objects. The features and components that exhibit the same effects are designated by the same reference symbols as appropriate, and the description thereof will not be repeated as appropriate. In the following description, reference characters L, R, F, Rr, U and D in the drawings represent left, right, front, rear, up, and down, respectively. These directional terms are, however, merely provided for purposes in illustration and are not intended to limit the present disclosure in any way.

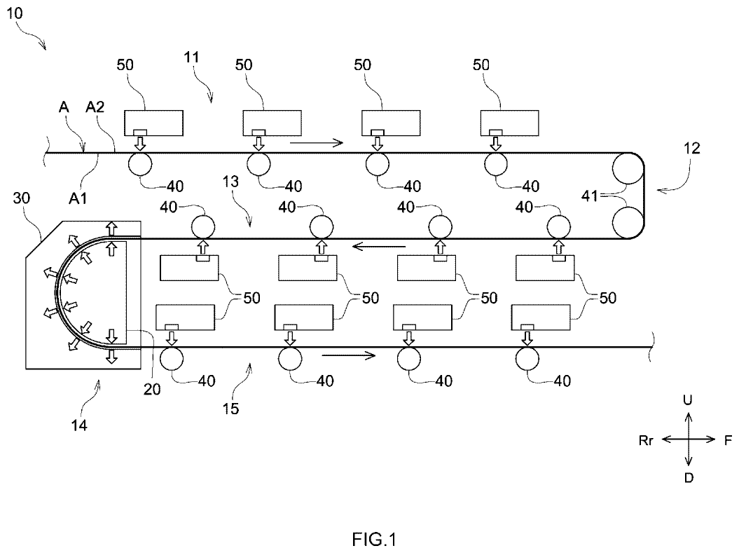

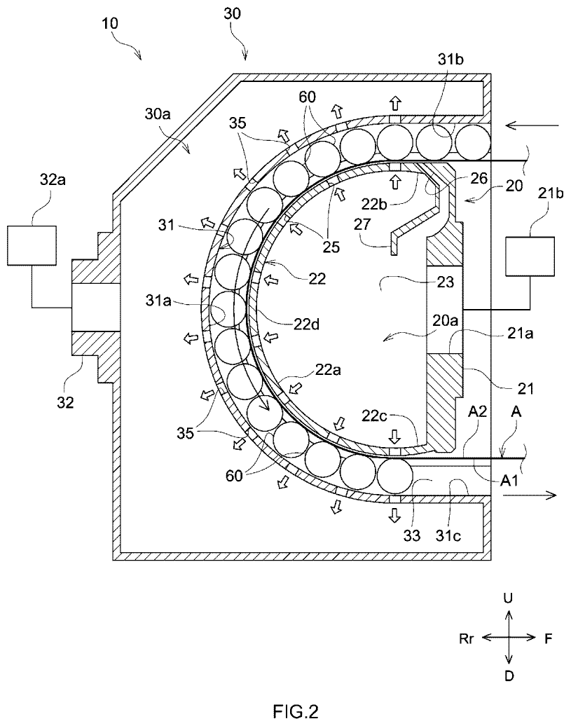

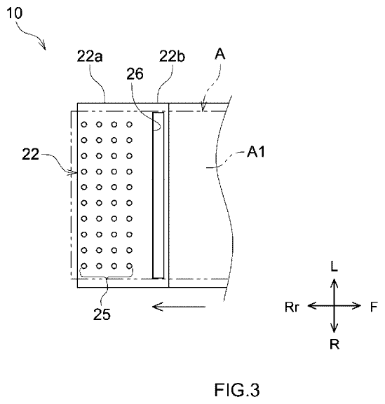

FIG. 1 is a schematic view of a sheet conveyor apparatus 10. FIG. 2 is a schematic cross-sectional view of an air turn bar 20 and a hood 30. FIG. 3 is a schematic plan view of the air turn bar 20. In FIGS. 1 to 3, the direction in which a sheet A is conveyed is indicated by the arrows. In FIGS. 1 and 2, the direction in which air is ejected is indicated by the white arrows.

### Sheet Conveyor Apparatus 10

The sheet conveyor apparatus 10 is an apparatus that conveys a strip-shaped electrode sheet (hereinafter also simply referred to as “sheet”) A that is used for an electrode of electricity storage devices. In the present description, the term “electricity storage device” is meant to encompass any type of device in which charge-discharge reactions are caused by migration of charge carriers between a pair of electrodes (positive electrode and negative electrode). Accordingly, the electricity storage devices according to the technology disclosed herein are intended to encompass secondary batteries, such as lithium-ion secondary batteries, nickel-metal hydride batteries, and nickel-cadmium batteries, as well as capacitors, such as lithium-ion capacitors and electric double-layer capacitors.

As illustrated in FIG. 1, the sheet A includes a current collector foil and a coated portion. The current collector foil is a strip-shaped metal foil. The coated portion is a layer containing an active material that is coated on one surface of the current collector foil. A coating device, not shown, that forms the coated portion on one surface of the current collector foil is provided upstream of the sheet conveyor apparatus 10. For the coating device, it is possible to use any conventionally known device that is used for manufacturing an electrode sheet of electricity storage devices, so the detailed description thereof is not provided herein.

The sheet A includes a non-coated surface A1, on which the coated portion is not formed, and a coated surface A2, on which the coated portion is formed. Conventionally known materials may be used for the materials that form the current collector foil and the coated portion, so the detailed description thereof is not provided herein. In the sheet A, the coated portion is formed on the current collector foil and dried. In this embodiment, the sheet A containing the coated portion before being dried is dried while being conveyed by the sheet conveyor apparatus 10. It is also possible that the sheet conveyor apparatus 10 may convey the sheet A containing the coated portion after being dried.

The sheet conveyor apparatus 10 includes an air turn bar 20 and a hood 30. The sheet conveyor apparatus 10 includes free rollers 40 and 41. The sheet conveyor apparatus 10 conveys the sheet A along a predetermined conveyance passage. The conveyance passage of the sheet A is defined by the air turn bar 20 and the free rollers 40 and 41. The conveyance passage of the sheet A includes a first conveying section 11, a first turn-back section 12, a second conveying section 13, a second turn-back section 14, and a third conveying section 15. The sheet A is conveyed in the following order, the first conveying section 11, the first turn-back section 12, the second conveying section 13, the second turn-back section 14, and the third conveying section 15. The second conveying section 13 is provided lower than the first conveying section 11. The third conveying section 15 is provided lower than the first conveying section 11 and the second conveying section 13.

The first conveying section 11, the second conveying section 13, and the third conveying section 15 are each provided with a plurality of drying nozzles 50 that dry the coated surface A2 of the sheet A. The plurality of drying nozzles 50 are provided intermittently along the conveying direction. The sheet A is dried by the drying nozzles 50 while being conveyed by the sheet conveyor apparatus 10. Each of the drying nozzles 50 is configured to eject air toward the coated surface A2. Although the configuration of the drying nozzles 50 is not particularly limited, it is possible to provide a plurality of air ejection holes along a width axis of the sheet A so that air can be applied to substantially uniformly along the width axis (the axis orthogonal to the conveying direction) of the sheet A. A plurality of free rollers 40 are provided at corresponding positions to the drying nozzles 50 across the sheet A. The sheet A is conveyed in a state in which the non-coated surface A1 is along the plurality of free rollers 40.

In the first conveying section 11, the sheet A is conveyed substantially horizontally toward the front with the non-coated surface A1 facing downward and the coated surface A2 facing upward. At positions opposing the coated surface A2 (above the coated surface A2), drying nozzles 50 are provided spaced apart from the sheet A. The coated surface A2 is dried by the air ejected from the drying nozzles 50. The non-coated surface A1 is supported by the free rollers 40 that are provided on the opposite side to the drying nozzles 50 (i.e., below). Because the non-coated surface A1 is supported by the free rollers 40, the sheet A does not sag easily even when air is blown onto the coated surface A2. This serves to keep the levelness of the sheet A and reduce vibrations of the sheet A, which makes the product quality of the sheet A after being dried more likely to improve.

At the first turn-back section 12, the sheet A is turned back by free rollers 41. In the embodiment, the sheet A is turned back by two free rollers 41. The sheet A is turned back with the non-coated surface A1 being along the free rollers 41. The two free rollers 41 are opposed in vertical directions. The upper end of the upper free roller 41 is set to be at substantially the same height as the upper ends of the free rollers 40 of the first conveying section 11 The lower end of the lower free roller 41 is set to be at substantially the same height as the lower ends of the free rollers 40 of the later-described second conveying section 13. The sheet A that is conveyed toward the front is guided downward by the free rollers 41. Thereafter, the sheet A is guided toward the rear by the free rollers 41.

In the second conveying section 13, the sheet A turned back by the first turn-back section 12 is conveyed substantially horizontally toward the rear with the non-coated surface A1 facing upward and the coated surface A2 facing downward. As in the first conveying section 11, at positions opposing the coated surface A2 (below the coated surface A2), drying nozzles 50 are provided spaced apart from the sheet A. The coated surface A2 is dried by the air ejected from the drying nozzles 50. The non-coated surface A1 is supported by the free rollers 40 that are provided on the opposite side to the drying nozzles 50 (i.e., above). Providing the second conveying section 13 with the free rollers 40 serves to easily keep the levelness of the sheet A and easily reduce vibrations of the sheet A.

At the second turn-back section 14, the sheet A is turned back by the air turn bar 20. The sheet A is turned back with the coated surface A2 facing inward and the non-coated surface A1 facing outward so that the coated surface A2 is opposed to the air turn bar 20. In this embodiment, the sheet A is turned back in such a condition as to be spaced apart from the air turn bar 20. In other words, the sheet A is turned back in such a condition as to be floated up from the air turn bar 20 so as not to come into contact with the air turn bar 20. The sheet A that has been turned back is conveyed toward the front again.

In the third conveying section 15, the sheet A turned back by the second turn-back section 14 is conveyed substantially horizontally toward the front with the non-coated surface A1 facing downward and the coated surface A2 facing upward. As in the first conveying section 11, at positions opposing the coated surface A2 (above the coated surface A2), drying nozzles 50 are provided spaced apart from the sheet A. The coated surface A2 is dried by the air ejected from the drying nozzles 50. The non-coated surface A1 is supported by the free rollers 40 that are provided on the opposite side to the drying nozzles 50 (i.e., below). Providing the third conveying section 15 with the free rollers 40 serves to easily keep the levelness of the sheet A and easily reduce vibrations of the sheet A.

After drying the coated portion, the sheet A conveyed by the sheet conveyor apparatus 10 undergoes processes such as a pressing process and a tab-formation process, to be manufactured into an electrode sheet.

In the following, the air turn bar 20 and the hood 30 provided in the second turn-back section 14 will be described.

### Air Turn Bar 20

The air turn bar 20 turns back a strip-shaped sheet A conveyed along the above-described conveyance passage. In this embodiment, the air turn bar 20 turns back the conveyed sheet A in the opposite direction. The air turn bar 20 extends along a direction orthogonal to the direction in which the sheet A is conveyed (i.e., along a left-right direction) (see FIG. 3). As illustrated in FIG. 2, the air turn bar 20 includes a base part 21, a protruding part 22, and a side surface part 23. The protruding part 22 protrudes in a circular arc-shaped cross section from the base part 21 toward the rear. An internal space 20a, which is surrounded by the base part 21, the protruding part 22, and the side surface part 23, is formed inside the air turn bar 20. In other words, the air turn bar 20 is configured to be hollow.

The base part 21 is a flat surface extending along a vertical direction and a left-right direction (see FIG. 3). The base part 21 is in a substantially rectangular shape. An air inlet hole 21a is provided substantially at the center of the base part 21. An air supply device 21b is connected to the air inlet hole 21a. The air supply device 21b is not particularly limited to any type of device as long as it can introduce air into the internal space 20a. For the air supply device 21b, it is possible to use, for example, a blower fan, a compressor, or the like. From the outer circumferential edge of the base part 21, the protruding part 22 and the side surface part 23 extend toward the rear.

The protruding part 22 includes a portion (semi-circular portion) 22a that is formed in a semi-circular cross-sectional shape when viewed in plan along the direction in which the air turn bar 20 extends. The protruding part 22 also includes an upstream portion 22b extending from the semi-circular shaped portion 22a toward the upstream side of the conveying direction of the sheet A, and a downstream portion 22c extending from the semi-circular shaped portion 22a toward the downstream side of the conveying direction. The upstream portion 22b is substantially parallel to the conveying direction in the second conveying section 13. The upstream portion 22b is connected to the upper end of the base part 21. The downstream portion 22c is connected to the lower end of the base part 21. Ejection holes 25 are formed in the outer circumferential surface of the air turn bar 20 that is within the protruding part 22. The ejection holes 25 are holes for ejecting air toward one surface (the coated surface A2 in this embodiment) of the sheet. The ejection holes 25 are opened in the protruding part 22 and are in communication with the internal space 20a of the air turn bar 20. A plurality of ejection holes 25 are provided in the protruding part 22.

The plurality of ejection holes 25 are provided in the semi-circular portion 22a. Each of the ejection holes 25 is a substantially circular shaped opening. Note that the shape of the ejection holes 25 is not limited to a circular shape but may be, for example, an elliptical shape, a polygonal shape, or the like. As illustrated in FIGS. 2 and 3, the plurality of ejection holes 25 are provided intermittently in the direction in which the air turn bar 20 extends and in the direction in which the semi-circular portion 22a curves. From the viewpoint of uniformly applying the air to the sheet A, the plurality of ejection holes 25 may be provided substantially at a uniform pitch at positions in the semi-circular portion 22a that oppose the sheet A. From the ejection holes 25, air is ejected toward the sheet A. From each ejection hole 25, air is ejected in a direction that is substantially orthogonal to the outer circumferential surface of the semi-circular portion 22a. This allows air to be blown onto the coated surface A2 of the sheet A. The sheet A may be turned back in a state such as to be floated from the outer circumferential surface of the air turn bar 20. In addition, blowing air onto the coated surface A2 may allow the coated surface A2 to dry.

In this embodiment, the upstream portion 22b of the protruding part 22 includes an upstream ejection hole 26 formed therein. The upstream ejection hole 26 is in communication with the internal space 20a (see FIG. 2) of the air turn bar 20. As illustrated in FIG. 3, the upstream ejection hole 26 is a slit-shaped opening extending along a direction in which the air turn bar 20 extends. In this embodiment, the upstream ejection hole 26 is longer than the width of the sheet A. The width of the upstream ejection hole 26 in the conveying direction of the sheet A is wider in its central portion than its widthwise end portions. Herein, the upstream ejection hole 26 is in a substantially rectangular shape that is longer in its width axis of the sheet A when viewed in plan. However, the shape of the upstream ejection hole 26 is not limited to any particular shape but may be in various shapes, such as a polygonal shape, a rhombus shape, an oblong hole with its widthwise end portions having a substantially circular shape, and an elliptical shape. The upstream ejection hole 26 may not necessarily be a slit-shaped opening but may be a similar shape to that of the ejection holes 25.

In this embodiment, the aperture ratio of the upstream portion 22b, which is configured by the upstream ejection hole 26, is greater than the aperture ratio of the semi-circular portion 22a, which is configured by the plurality of ejection holes 25. The aperture ratio may be calculated by the area of the openings per unit area. Making the aperture ratio of the upstream portion 22b greater may accordingly make the buoyant force resulting from the air ejected from the upstream portion 22b greater than the buoyant force resulting from the air ejected from the semi-circular portion 22a.

As illustrated in FIG. 2, the inside of the air turn bar 20 is provided with a vane plate 27 that guides the air flowing toward the upstream ejection hole 26. The vane plate 27 serves to set the direction of the air flowing toward the upstream ejection hole 26. In this embodiment, the vane plate 27 extends downward from the upper end of the upstream portion 22b. The vane plate 27 extending downward from the upper end of the upstream portion 22b is inclined toward the front at its upper end portion. This sets the direction of the air ejected from the upstream ejection hole 26 to be obliquely upward (rearward and upward).

The side surface part 23 is a part that closes a side surface of the air turn bar 20. The side surface part 23 is provided at each end portion of the air turn bar 20 along the direction in which the air turn bar 20 extends. The side surface part 23 is connected to the end portions of the base part 21 and the protruding part 22 in the direction in which the air turn bar 20 extends. The shape of the side surface part 23 is a shape that corresponds to the shapes of the base part 21 and the protruding part 22. In this embodiment, the side surface part 23 is in a substantially semi-circular shape.

Supplying air into the internal space 20a of the air turn bar 20 increases the pressure in the internal space 20a, causing the air to be ejected from the ejection holes 25 and the upstream ejection hole 26. By blowing air from the ejection holes 25 and the upstream ejection hole 26 provided in the outer circumferential surface (the protruding part 22) of the air turn bar 20 toward the sheet A, the sheet A is turned back while the air is being blown thereto. This causes the sheet A to be turned back in such a condition as to be floated up from the outer circumferential surface of the air turn bar 20 so as not to come into contact with the air turn bar 20. At the position at which the sheet A is turned back, the outside of the sheet A is covered by the hood 30.

### Hood 30

The hood 30 includes an inner circumferential surface 31 that opposes the outer circumferential surface (the protruding part 22 in this embodiment) of the air turn bar 20. The inner circumferential surface 31 of the hood 30 is in a shape that follows the protruding part 22 of the air turn bar 20. The inner circumferential surface 31 of the hood 30 includes an opposing portion 31b that opposes the upstream portion 22b of the air turn bar 20. The inner circumferential surface 31 of the hood 30 also includes a portion 31a that opposes the semi-circular portion 22a of the air turn bar 20 and a portion 31c that opposes the downstream portion 22c. In this embodiment, the portion 31a of the inner circumferential surface 31 of the hood 30 that opposes the semi-circular portion 22a is in a substantially semi-circular shape when viewed in a cross section along the direction in which the air turn bar 20 extends. The opposing portion 31b of the inner circumferential surface 31 of the hood 30 that opposes the upstream portion 22b is substantially flat. The portion 31c of the inner circumferential surface 31 of the hood 30 that opposes the downstream portion 22c is substantially flat. An internal space 30a is formed inside the hood 30. In other words, the hood 30 is configured to be hollow.

The hood 30 is provided with a hose flange 32. The hose flange 32 is provided with a suction hole formed therein and is connected to an air suction device 32a. The air suction device 32a reduces the pressure in the internal space 30a to be lower than that of the external space. The air suction device 32a is not particularly limited to any type of device as long as it can suck air from the internal space 30a of the hood 30. For the air suction device 32a, it is possible to use, for example, a vacuum pump or the like.

The inner circumferential surface 31 of the hood 30 includes suction holes 35 formed therein. The suction holes 35 are holes for sucking air from the other surface (the non-coated surface A1 in this embodiment) of the sheet A. A plurality of suction holes 35 are provided in the inner circumferential surface 31 of the hood 30. In this embodiment, the suction holes 35 are formed in a region of the inner circumferential surface 31 of the hood 30 that opposes the outer circumferential surface (the protruding part 22) of the air turn bar 20. Each of the suction holes 35 is a substantially circular shaped opening. Note that the shape of the suction holes 35 is not limited to a circular shape but may be, for example, an elliptical shape, a polygonal shape, or the like. The plurality of suction holes 35 are provided intermittently in the widthwise direction and the direction in which the inner circumferential surface 31 curves. From the viewpoint of uniformly sucking the sheet A, the plurality of suction holes 35 may be provided substantially at a uniform pitch at positions in the inner circumferential surface 31 that oppose the sheet A.

In some cases, when a sheet is turned back by an air turn bar provided with ejection holes through which air is ejected, the blowing air may cause the sheet to flutter. When the sheet flutters, there is a fear that the sheet and the air turn bar may come into contact with each other. The contacting between the sheet and the air turn bar may cause damage to the contacted portion, reducing the product quality of the manufactured electrode sheet.

According to the above-described embodiment, the sheet conveyor apparatus 10 includes an air turn bar 20 and a hood 30. The air turn bar 20 turns back a strip-shaped sheet A conveyed along a predetermined conveyance passage. The hood 30 includes an inner circumferential surface 31 that opposes the outer circumferential surface (the protruding part 22 in this embodiment) of the air turn bar 20. In the outer circumferential surface of the air turn bar 20, ejection holes 25 are formed that eject air toward one surface (the coated surface A2 in this embodiment) of the sheet A. In the inner circumferential surface 31 of the hood 30, suction holes 35 are formed that suck air from the other surface (the non-coated surface A1 in this embodiment) of the sheet A. Such a sheet conveyor apparatus 10 ejects air from the ejection holes 25 of the air turn bar 20, so that the coated surface A2 of the sheet A is less likely to come into contact with the air turn bar 20. Moreover, because air is sucked through the suction holes 35 of the hood 30, the sheet A is also sucked from the non-coated surface A1 side. This causes the coated surface A2 of the sheet A to be even less likely to come into contact with the air turn bar 20. In addition, by blowing air onto the sheet A from the coated surface A2 side and also sucking air from the non-coated surface A1 side, the volume of the air blown from the air turn bar 20 can be reduced. This reduces fluttering of the sheet A. Because the coated surface A2 of the sheet A is less likely to come into contact with the air turn bar 20, the coated surface A2 of the sheet A is less likely to be damaged, and the product quality of the manufactured electrode sheet improves.

In the above-described embodiment, the outer circumferential surface of the air turn bar 20 includes a semi-circular cross-sectional shaped portion (semi-circular portion) 22a. The air turn bar 20 turns back the conveyed sheet A in an opposite direction. Turning back the sheet A in an opposite direction allows the conveyance passage of the sheet A to be longer in a limited space. This may reduce the size of the equipment that processes the sheet A. It should be noted that the sheet A does not need to be turned back in an opposite direction but may be turned back at any desired angle. The outer circumferential surface of the air turn bar 20 may not necessarily be in a semi-circular cross-sectional shape, but may be in a fan-shaped cross-sectional shape or the like, for example.

In the above-described embodiment, the outer circumferential surface of the air turn bar 20 includes an upstream portion 22b extending from the semi-circular cross-sectional shaped portion 22a toward the upstream of the conveying direction of the sheet A. In the upstream portion 22b, an upstream ejection hole 26 is formed that eject air toward one surface of the sheet A. To the knowledge of the present inventors, negative pressure is likely to produce in the upstream of the air turn bar 20 at which the sheet A starts to be turned back. This tends to cause the sheet A to be pulled downward toward the air turn bar 20. Provision of the upstream ejection hole 26 in the upstream portion 22b of the air turn bar 20 may cause the buoyant force to be greater at the position at which the sheet A starts to be turned back. As a result, the position at which the sheet A starts to be turned back is less likely to come into contact with the air turn bar 20.

In the above-described embodiment, the suction holes 35 are formed in a region of the inner circumferential surface 31 of the hood 30 that opposes the outer circumferential surface (the protruding part 22) of the air turn bar 20. The suction holes 35 may be formed in at least a region of the inner circumferential surface 31 of the hood 30 that opposes a turn end portion 22d of the outer circumferential surface (the protruding part 22) of the air turn bar 20. Due to the tension or the like in conveying the sheet A, the sheet A is likely to come into contact with the turn end portion 22d of the air turn bar 20. Forming the suction holes 35 in the region that opposes the turn end portion 22d allows the air turn bar 20 and the sheet A to be less likely to come into contact with each other.

It should be noted that, as illustrated in FIG. 2, the sheet conveyor apparatus 10 includes a plurality of guide rollers 60. Each of the plurality of guide rollers 60 is a cylindrical roller the rotational axis of which is set along the width direction of the sheet A. The plurality of guide rollers 60 are not connected to a drive device or the like, so they rotate in a driven manner. The plurality of guide rollers 60 are provided between the outer circumferential surface (the protruding part 22) of the air turn bar 20 and the inner circumferential surface 31 of the hood 30. The plurality of guide rollers 60 are arranged along the outer circumferential surface (the protruding part 22) of the air turn bar 20 and the inner circumferential surface 31 of the hood 30. The plurality of guide rollers 60 are arrayed spaced from each other in a circular arc shape. In this embodiment, the plurality of guide rollers 60 are supported by side walls 33 provided so as to cover both ends of the sheet A along the width direction in the conveyance passage of the sheet A. The side walls 33 oppose each other in a left-right direction across the conveyance passage of the sheet A. The form of supporting the plurality of guide rollers 60 is not limited to any particular manner.

The sheet A is allowed to pass between the air turn bar 20 and the plurality of guide rollers 60. The guide rollers 60 are what are called free rollers, which may rotate by being driven by the sheet A conveyed along the outer circumferential surfaces of the guide rollers 60.

The sheet A is pushed in a direction extending from the outer circumferential surface of the air turn bar 20 toward the inner circumferential surface 31 of the hood 30 due to the air ejected through the ejection holes 25 of the air turn bar 20 and the suction through the suction holes 35 of the hood 30. In this embodiment, the plurality of guide rollers 60 are provided on the outside (the non-coated surface A1 side) of the sheet A. This allows the sheet A to be conveyed in a state such as to be in contact with the plurality of guide rollers 60. As a result, it is possible to reduce fluttering of the sheet A in conveying. Moreover, the gap between the coated surface A2 and the air turn bar 20 is maintained easily, and therefore, the risk of contacting the sheet A and the air turn bar 20 with each other may be reduced.

As described previously, negative pressure is likely to produce in the upstream of the air turn bar 20 at which the sheet A starts to be turned back. Provision of the upstream ejection hole 26 in the upstream portion 22b of the air turn bar 20 causes the buoyant force to be greater at the position at which the sheet A starts to be turned back. In this embodiment, the plurality of guide rollers 60 are also provided between the opposing portion 31b of the inner circumferential surface 31 of the hood 30 and the upstream portion 22b of the outer circumferential surface (the protruding part 22) of the air turn bar 20. This allows the sheet A to be pressed against the guide rollers 60 to follow the guide rollers 60 easily even when the buoyant force is made greater at the position at which the sheet A starts to be turned back. As a result, fluttering of the sheet A is reduced, and the conveying of the sheet A is made more stable.

The above-described embodiment has described an embodiment of the sheet conveyor apparatus 10 in which the sheet A including the non-coated surface A1 and the coated surface A2 is turned back. However, the sheet A to be turned back is not limited to such an embodiment. The sheet conveyor apparatus 10 may also be used when turning back a sheet in which coated surfaces are formed on both surfaces and when turning back a sheet in which no coated surface is formed. The sheet is less likely to come into contact with the air turn bar and is accordingly less likely to be damaged when the sheet is turned back. This may improve the quality of the products that are manufactured using the sheet. In addition, the conveyance passage of the sheet is not limited to the above-described passage including the first conveying section 11, the first turn-back section 12, the second conveying section 13, the second turn-back section 14, and the third conveying section 15. The technology disclosed herein may be used when a conveyance passage is set such that a sheet is turned back by an air turn bar. The angle at which the sheet is to be turned back is not limited to any particular angle.

Various embodiments of the technology according to the present disclosure have been described hereinabove. Unless specifically stated otherwise, the embodiments described herein do not limit the scope of the present disclosure. It should be noted that various other modifications and alterations may be possible in the embodiments of the technology disclosed herein. In addition, the features, structures, or steps described herein may be omitted as appropriate, or may be combined in any suitable combinations, unless specifically stated otherwise. In addition, the present description includes the disclosure as set forth in the following items.

### Item 1:

A sheet conveyor apparatus including:
an air turn bar turning back a strip-shaped sheet conveyed along a predetermined conveyance passage; and
a hood including an inner circumferential surface opposing an outer circumferential surface of the air turn bar, wherein:
the outer circumferential surface of the air turn bar includes an ejection hole ejecting air toward one surface of the sheet; and
the inner circumferential surface of the hood includes a suction hole sucking air from another surface of the sheet.

### Item 2:

The sheet conveyor apparatus according to item 1, further including a plurality of guide rollers arranged along the outer circumferential surface of the air turn bar and the inner circumferential surface of the hood.

### Item 3:

The sheet conveyor apparatus according to item 1 or 2, wherein:
the outer circumferential surface of the air turn bar includes a semi-circular cross-sectional shaped portion; and
the air turn bar turns back the conveyed sheet in an opposite direction.

### Item 4:

The sheet conveyor apparatus according to item 3, wherein:
the outer circumferential surface of the air turn bar includes an upstream portion extending from the semi-circular cross-sectional shaped portion toward an upstream of a conveying direction of the sheet; and
the upstream portion includes an upstream ejection hole ejecting air toward the one surface of the sheet.

### Item 5:

The sheet conveyor apparatus according to item 4, wherein:
the inner circumferential surface of the hood includes an opposing portion opposing the upstream portion; and
further including a guide roller disposed between the opposing portion of the inner circumferential surface of the hood and the upstream portion of the outer circumferential surface of the air turn bar.

### Item 6:

The sheet conveyor apparatus according to any one of items 1 through 4, wherein the suction hole is formed in at least a region of the inner circumferential surface of the hood that opposes a turn end portion of the outer circumferential surface of the air turn bar.

What is claimed is:

1. A sheet conveyor apparatus comprising:
an air turn bar turning back a strip-shaped sheet conveyed along a predetermined conveyance passage; and
a hood including an inner circumferential surface opposing an outer circumferential surface of the air turn bar, wherein:
the outer circumferential surface of the air turn bar includes an ejection hole ejecting air toward one surface of the sheet; and
the inner circumferential surface of the hood includes a suction hole sucking air from another surface of the sheet.

2. The sheet conveyor apparatus according to claim 1, further comprising a plurality of guide rollers arranged along the outer circumferential surface of the air turn bar and the inner circumferential surface of the hood.

3. The sheet conveyor apparatus according to claim 1, wherein:
the outer circumferential surface of the air turn bar includes a semi-circular cross-sectional shaped portion; and
the air turn bar turns back the conveyed sheet in an opposite direction.

4. The sheet conveyor apparatus according to claim 3, wherein:
the outer circumferential surface of the air turn bar includes an upstream portion extending from the semi-circular cross-sectional shaped portion toward an upstream of a conveying direction of the sheet; and
the upstream portion includes an upstream ejection hole ejecting air toward the one surface of the sheet.

5. The sheet conveyor apparatus according to claim 4, wherein:
the inner circumferential surface of the hood includes an opposing portion opposing the upstream portion; and
further comprising a guide roller disposed between the opposing portion of the inner circumferential surface of the hood and the upstream portion of the outer circumferential surface of the air turn bar.

6. The sheet conveyor apparatus according to claim 1, wherein the suction hole is formed in at least a region of the inner circumferential surface of the hood that opposes a turn end portion of the outer circumferential surface of the air turn bar.
